(19) United States
(12) Patent Application Publication
(10) Pub. No.: US 2024/0109190 A1
(43) Pub. Date: Apr. 4, 2024

(54) Robot Control System, Robot Control Method, and Program

(71) Applicant: Hitachi, Ltd., Chiyoda-ku, Tokyo (JP)

(72) Inventor: Satoshi NAKAMURA, Chiyoda-ku, Tokyo (JP)

(21) Appl. No.: 18/285,343

(22) PCT Filed: Feb. 2, 2022
(86) PCT No.: PCT/JP2022/003944

§ 371 Date: Oct. 2, 2023

(30) Foreign Application Priority Data
Apr. 27, 2021 (JP) 2021-075177

(51) Int. Cl. B25J 9/16

(52) U.S. Cl. CPC B25J 9/163; B25J 9/1661; B25J 9/1694

(57) ABSTRACT

One aspect of the present invention is provided with: a calculation processing unit for, by using a learning model, inferring and outputting progress in a work step and a type of a work target object corresponding to information indicating the current work situation of a robot device, acquired by a work situation sensor; and an operation selection unit that selects an operation pattern generation unit from one or more operation pattern generation units each for generating an operation pattern of a robot device 1 corresponding to the current work step, on the basis of the inferred type of the work target object and the inferred progress in the current work step.

### TECHNICAL FIELD

The present invention relates to a robot control system, a robot control method, and a program that control a robot device which performs work.

### BACKGROUND ART

Conventionally, a robot device such as an industrial robot or a mobile robot is configured to repeatedly execute actions, which are mainly stored, in order. For this reason, in work in which a plurality of workpieces need to be handled at various timings and in various situations, robot devices have sometimes been incapable of autonomously executing actions suitable for the workpieces. Therefore, systems are known that discriminate a workpiece of a robot device by using image data captured by a camera or the like and that perform control to cause the robot device to execute an action on the basis of the discrimination result.

For example, PTL 1 discloses a robot control method that includes an attribute detection step of detecting attributes of a workpiece, a control condition setting step of setting a control condition on the basis of the workpiece attributes and behavior information stored in a storage unit, and a movement step of moving the workpiece on the basis of the control condition set in the control condition setting step. Workpiece attributes are, for example, shape, dimensions, weight, and flexibility.

### CITATION LIST

### Patent Literature

PTL 1: JP 2010-264559 A

### SUMMARY OF INVENTION

### Technical Problem

Meanwhile, work applied to a robot device that performs work autonomously is relatively simple work such as pick-and-place, and one work activity with respect to one workpiece is often completed by a single action. However, in work such as assembly, installation, disassembly, repair, and so forth, it is necessary to execute several processes in combination so as to perform a plurality of actions on one workpiece.

In the robot control method disclosed in PTL 1, because only one action corresponding to one estimated type of object is selected, all the actions necessary for work cannot be executed, and work combining a plurality of processes can, in some cases, not be handled.

In view of the above situation, there has been a demand for a method of selecting an action pattern of a robot device so that the robot device is capable of performing an appropriate action with respect to work requiring a plurality of processes.

### Solution to Problem

In order to solve the above problems, a robot control system according to one aspect of the present invention includes: a robot device; a work status sensor that acquires information indicating a work status of the robot device with respect to a workpiece; an arithmetic processing unit that estimates and outputs a workpiece type and progress of a current work process, which correspond to information indicating a current work status acquired by the work status sensor by using a learning model subjected to machine learning by means of training data which includes the information indicating the work status acquired by the work status sensor, the workpiece type, and the progress of the work process; at least one or more action pattern generation units that generate an action pattern of the robot device corresponding to the current work process; and an action selection unit that selects the action pattern generation unit on the basis of the workpiece type and the work process progress outputted by the arithmetic processing unit.

### Advantageous Effects of Invention

In at least one aspect of the present invention, the action content of the robot device is determined on the basis of the progress of the current work process estimated by the learning model by using the learning model trained to estimate the workpiece type and the progress of the work process with respect to information indicating the work status of the robot device. Accordingly, one aspect of the present invention can cause the robot device to execute an appropriate action in work requiring a plurality of processes.

Problems, configurations, advantageous effects, and the like other than those described above will be clarified by the following descriptions of the embodiments.

### BRIEF DESCRIPTION OF DRAWINGS

FIG. 1 is a schematic view illustrating an example of the overall configuration of a robot control system according to a first embodiment of the present invention.

FIG. 2 is a schematic view illustrating an example of a hardware configuration for executing software of the robot control system according to the first embodiment of the present invention.

FIG. 3 is an external view illustrating an example of work by the robot device.

FIG. 4 is a schematic view illustrating an example of a software configuration of a learning program for machine learning of a learning model, the program being stored in a learning-type control device of the robot control system according to the first embodiment of the present invention.

FIG. 5 is a schematic view illustrating an example of training data which a learning program uses in machine learning of a learning model, in the robot control system according to the first embodiment of the present invention.

FIG. 6 is a schematic view illustrating an example of a software configuration of an action command program that executes control by using a learning model subjected to machine learning, the program being stored in the learning-type control device of the robot control system according to the first embodiment of the present invention.

FIG. 7 is a flowchart illustrating a procedure example of a method in which an action command program executes control by using a learning model subjected to machine learning, in the robot control system according to the first embodiment of the present invention.

FIG. 8 is a schematic view illustrating an example of training data which a learning program uses in machine learning of a learning model, in the robot control system according to a second embodiment of the present invention.

FIG. 9 is a schematic view illustrating an example of training data which a learning program uses in machine learning of a learning model, in the robot control system according to a third embodiment of the present invention.

FIG. 10 is a flowchart illustrating a procedure example of a method in which an action command program executes control by using a learning model subjected to machine learning, in the robot control system according to the third embodiment of the present invention.

FIG. 11 is a schematic view illustrating an example of the overall configuration of a robot control system according to a fourth embodiment of the present invention.

FIG. 12 is a schematic view illustrating an example of training data which a learning program uses in machine learning of a learning model, in the robot control system according to the fourth embodiment of the present invention.

### DESCRIPTION OF EMBODIMENTS

Hereinafter, examples of modes for carrying out the present invention will be described with reference to the accompanying drawings. In the present specification and the accompanying drawings, constituent elements having substantially the same function or configuration are denoted by the same reference numerals, and redundant descriptions thereof are omitted.

### First Embodiment

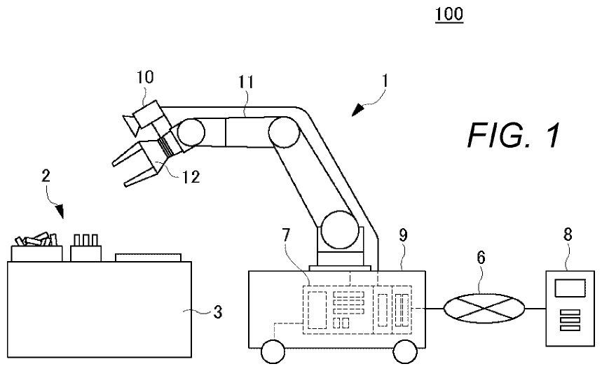

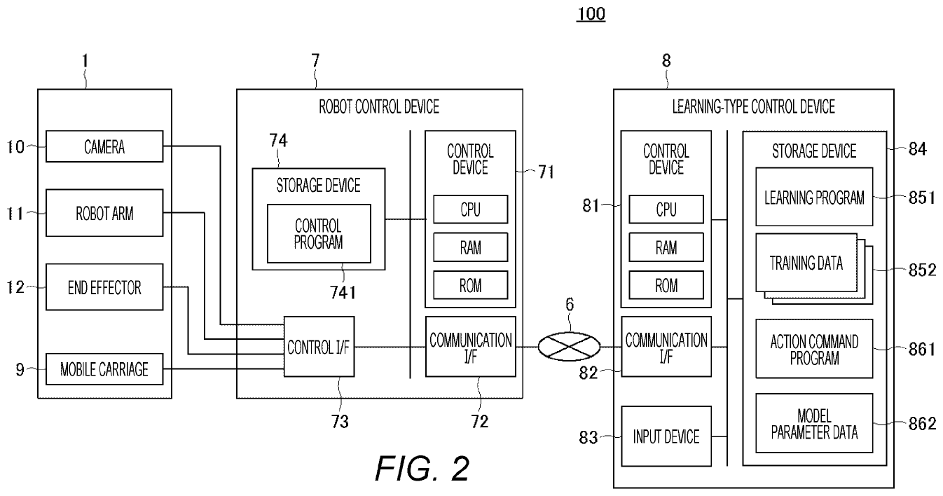

First, a configuration of a robot device according to a first embodiment of the present invention and a configuration of a robot control system that controls the robot device will be described with reference to FIGS. 1 and 2.

### [Overall Configuration of Robot Control System]

FIG. 1 is a schematic view illustrating an example of the overall configuration of a robot control system according to the first embodiment. In the illustrated robot control system 100, the robot device 1 includes a mobile carriage 9, a robot arm 11 attached on the mobile carriage 9, an end effector 12 attached to a distal end of the robot arm 11, and a camera 10 attached near the end effector 12. The robot arm 11 has one or more joints, and is capable of acting freely by driving an actuator such as a motor (not illustrated) provided to the joint(s).

Each device of the robot device 1 is connected to a robot control device 7 installed on the mobile carriage 9. Each device of the robot device 1 acts in response to a control command (a motor current of the robot arm 11, a motor current of the end effector 12, or the like) from the robot control device 7. The robot device 1 performs work with respect to the workpiece 2 on the workbench 3 by driving the robot arm 11 and the end effector 12. Each device of the robot device 1 transmits information indicating the state of the robot device 1 to the robot control device 7. The information indicating the state of the robot device 1 is, for example, a joint angle of the robot arm 11, an image (camera image) captured by the camera 10, and the like. Hereinafter, the information indicating the state of the robot device 1 may be simply referred to as the “state of the robot device 1”.

The camera 10 has a function for obtaining an image signal (camera image) of an optical image containing the workpiece 2, which is handled by the robot device 1 as a subject. The camera 10 is an example of a work status sensor that acquires information indicating a work status of the robot device 1. For example, an imaging device that captures an image including at least the workpiece 2 as the information indicating the work status of the robot device 1 can be used as the camera 10. In addition, the camera image is desirably set at a viewing angle that enables the entire upper surface of the workbench 3 to be photographed.

The robot control device 7 is connected to a learning-type control device 8 via a network 6 such as the Internet or a LAN. The robot control device 7 transmits information indicating the state of the robot device 1 obtained from the robot device 1 to the learning-type control device 8 via the network 6. The robot control device 7 also calculates a control command for the robot device 1 on the basis of an action command (target joint angle of robot arm 11, and the like) outputted from the learning-type control device 8 and the information indicating the state of the robot device 1 inputted from the robot device 1.

Note that, although the robot device 1 is a control target of the robot control system 100, the robot control system 100 may also be configured excluding the robot device 1.

### [Hardware Configuration of Robot Control System]

FIG. 2 is a schematic view illustrating an example of a hardware configuration for executing software of the robot control system 100. Note that, in FIG. 2, the interface is referred to as an “I/F”.

### (Robot Control Device)

The robot control device 7 is a computer in which a control device 71, a communication interface 72, a control interface 73, and a storage device 74 are electrically connected to each other via a system bus. The control device 71 includes a central processing unit (CPU), a random access memory (RAM), a read only memory (ROM), and the like, and is configured to execute information processing on the basis of a program and various data for realizing the functions according to the present embodiment. Another processing device such as a micro processing unit (MPU) may also be used instead of a CPU.

The communication interface 72 is an interface that is connected to the learning-type control device 8 and which is for sending and receiving action commands for the robot device 1 and data related to the state of the robot device 1. The communication interface 72 communicates with the communication interface 82 of the learning-type control device 8 via the network 6.

The control interface 73 is an interface that is connected to the robot device 1 and which is for sending and receiving control commands for the robot device 1 and data related to the state of the robot device 1. The control interface 73 is appropriately configured according to the equipment constituting the robot device 1. Because the configuration of the robot device 1 connected to the control interface 73 has been described with reference to FIG. 1, a description thereof is omitted here.

The storage device 74 is an auxiliary storage device such as a hard disk drive or a semiconductor memory, and stores a control program 741 or the like executed by the control device 71. The ROM and the storage device 74 permanently record programs, data, and the like necessary for the CPU of the control device 71 to operate, and are used as an example of a computer-readable non-transitory recording medium that stores programs executed by the CPU. When activated by turning on the power, or the like, the robot control device 7 deploys the control program 741, which is stored in the storage device 74, in the RAM of the control device 71 and executes the control program.

The control program 741 generates a control command for the robot device 1 on the basis of the action command generated by the learning-type control device 8 inputted from the communication interface 72 and the information indicating the state of the robot device 1 inputted from the control interface 73. The control program 741 then outputs a control command to the robot device 1 from the control interface 73. In addition, the control program 741 outputs information indicating the state of the robot device 1, which is inputted from the control interface 73, from the communication interface 72 to the learning-type control device 8.

### (Learning-Type Control Device)

The learning-type control device 8 is a computer in which a control device 81, a communication interface 82, an input device 83, and a storage device 84 are electrically connected to each other via a system bus. The control device 81 includes a CPU, a RAM, a ROM, or the like, and is configured to execute information processing on the basis of programs and various data that realize the functions according to the present embodiment.

The communication interface 82 is an interface that is connected to the robot control device 7 and which is for sending and receiving action commands for the robot device 1 and information indicating the state of the robot device 1 to and from the robot control device 7. The communication interface 82 communicates with the communication interface 72 of the robot control device 7 via the network 6.

The input device 83 is a device that receives inputs from a user, such as a mouse or a keyboard, and controls the program execution or the like of the learning-type control device 8.

The storage device 84 is an auxiliary storage device such as a hard disk drive or a semiconductor memory, and stores a learning program 851, an action command program 861, which are executed by the control device 81, training data 852, model parameter data 862, and the like. The ROM and the storage device 84 permanently record programs, data, and the like necessary for the CPU of the control device 81 to operate, and are used as an example of a computer-readable non-transitory recording medium that stores programs executed by the CPU. When activated by turning on the power or the like, the learning-type control device 8 deploys the learning program 851 and the action command program 861, which are stored in the storage device 84, in the RAM of the control device 81.

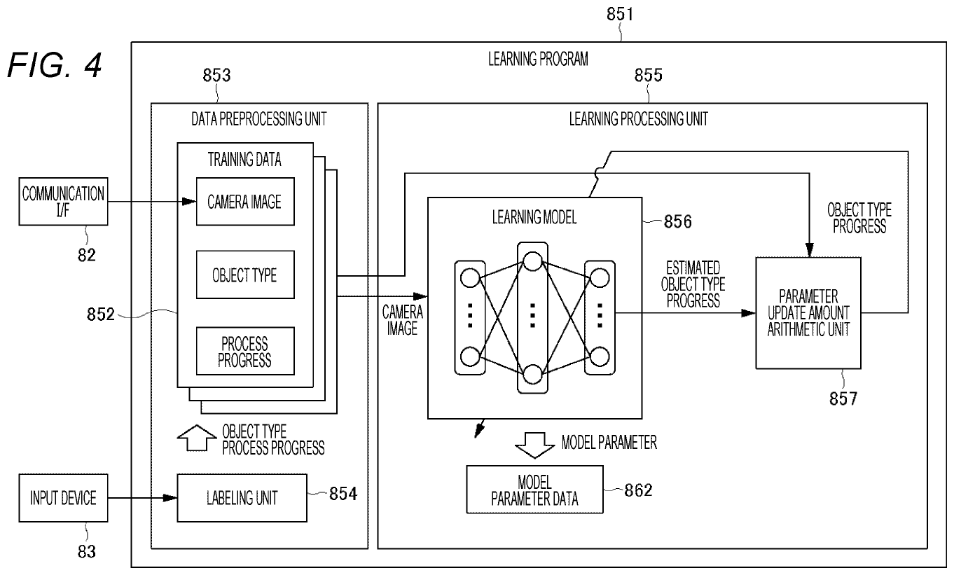

When execution of learning is instructed by the user via the input device 83, the learning program 851 generates the training data 852 by using the information indicating the state of the robot device 1 inputted from the communication interface 82 and records the generated training data in the storage device 84. The learning program 851 then performs machine learning on a learning model 856 (see FIG. 4) (described below) by means of the training data 852, and generates the model parameter data 862 as trained parameters. The learning model 856 is a so-called supervised learning model.

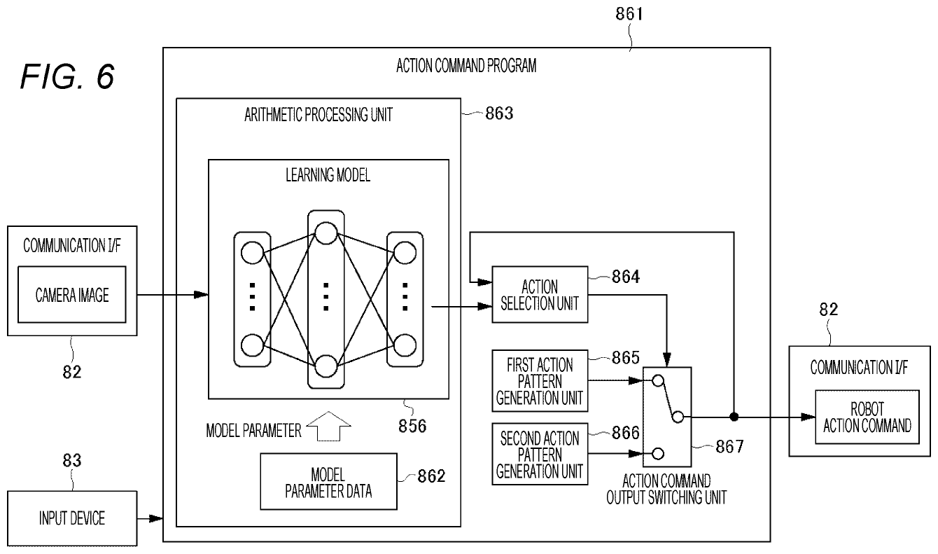

When execution of control of the robot device 1 is instructed by the user via the input device 83, the action command program 861 reads the model parameter data 862. The action command program 861 then calculates an action command for the robot device 1 by using the state of the robot device 1 obtained from the communication interface 82 and the learning model 856 (see FIG. 6) (described below). The learning model 856 illustrated in FIG. 6 is a trained model (inference program) mirroring learning results (model parameter data 862). The action command program 861 outputs the generated action command for the robot device 1 from the communication interface 82 to the robot control device 7. The robot control device 7 outputs a control command for the robot device 1 on the basis of the action command of the robot device 1 inputted from the learning-type control device 8 to control the actions of the robot device 1.

Note that the robot control device 7 and the learning-type control device 8 are not limited to being connected via the network 6. The robot control device 7 and the learning-type control device 8 may have a configuration in which the communication interface 72 and the communication interface 82 are directly connected by a dedicated line or the like. Further, the control interface 73 and the communication interface 72 may be the same, and the robot control device 7 may be configured to output a control command to the robot device 1 via the network 6.

In addition, the learning program 851 and the action command program 861 need not be stored in the same learning-type control device 8, and may be stored in different learning-type control devices. For example, the learning-type control device 8 may be configured to communicate the training data 852 and the model parameter data 862 with a learning-type control device at another site via the network 6.

In addition, the learning-type control device 8 and the robot control device 7 may be configured by the same hardware. That is, the control program 741, the learning program 851, and the action command program 861 may be configured to be executed on the same hardware.

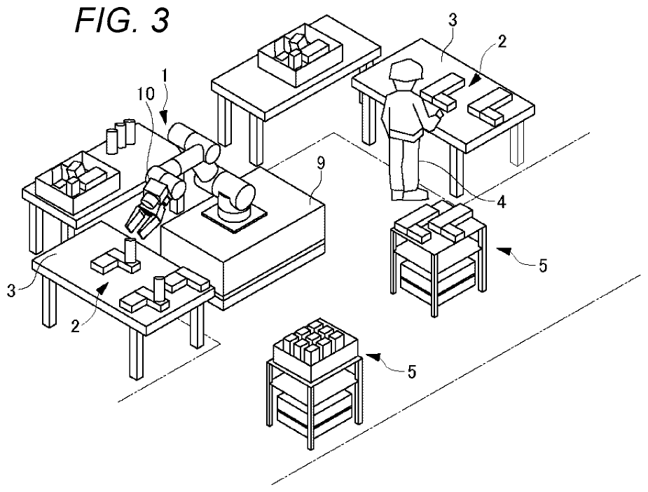

Next, a method in which, in the robot control system 100, the learning-type control device 8 learns the type of the workpiece 2 (hereinafter also referred to as “object type”) and the progress of the work process (hereinafter also referred to as the “process progress”) in association with each other, and determines the action of the robot device 1 on the basis of the process progress will be described with reference to FIGS. 3 to 7.

### [Example of Work Executed by Robot Device]

FIG. 3 is an external view illustrating an example of work executed by the robot device 1. A work example of the robot device 1 will be described with reference to FIG. 3.

At a site where high-mix, low-volume production is performed, work including a plurality of processes (assembly work and the like) such as a cell production method is sometimes performed in one work location (cell). For example, as illustrated in FIG. 3, there is work in which the robot device 1 or a worker 4 assembles a workpiece 2 disposed on the workbench 3 or a workpiece 2 which is being conveyed by an automatic conveyance vehicle 5. In work at such a site, work content is sometimes replaced in response to a change in demand of a product. For example, the worker 4 who has been performing the assembly work may move to a different workbench 3 to perform the work in accordance with a modified production plan, and the robot device 1 may continue the assembly work performed by the worker 4. In addition, the workpiece 2 being conveyed by the automatic conveyance vehicle 5 may be changed according to the modified production plan, thereby changing the work content of the assembly work.

In order for the robot device 1 to appropriately execute work at the above-described site, the robot device 1 needs to recognize the type and work status of the workpiece 2 and execute an appropriate action. That is, it is desirable for the robot device 1 to be capable of recognizing the progress status of the work on the workpiece 2 and of continuing the appropriate work on the workpiece 2 on the basis of the progress.

### [Method of Learning Object Type and Process Progress]

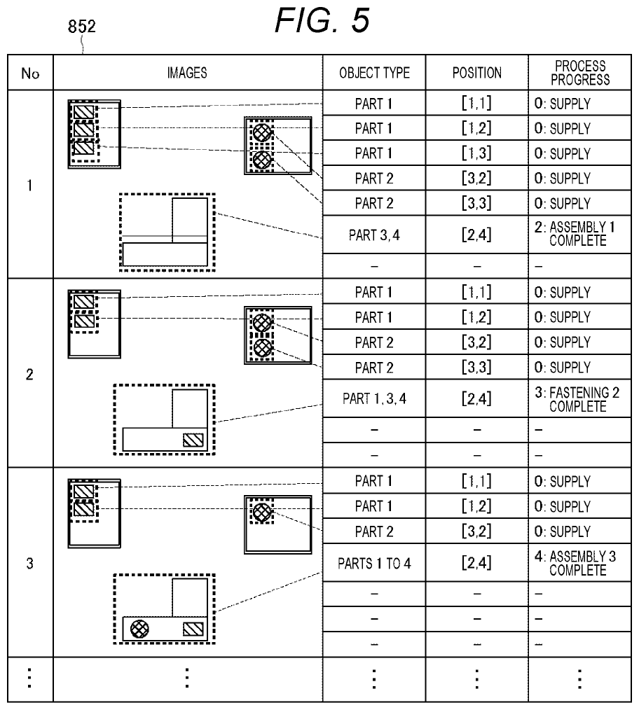

Next, a method in which the learning-type control device 8 learns the object type and the process progress will be described with reference to FIGS. 4 and 5.

FIG. 4 is a schematic view illustrating an example of a software configuration of a learning program 851 for machine learning of a learning model 856, the program being stored in the learning-type control device 8 of the robot control system 100. FIG. 5 is a schematic view illustrating an example of training data 852 which a learning program uses in machine learning of a learning model, in the robot control system 100.

The learning program 851 is configured to include a data preprocessing unit 853, a labeling unit 854, and a learning processing unit 855 as software modules when deployed in the RAM of the control device 81 and executed by the CPU.

The data preprocessing unit 853 records the camera image of the camera 10 inputted from the communication interface 82. In addition, the data preprocessing unit 853 includes a labeling unit 854 that associates a label for the object type of the workpiece 2 in the camera image with a label for process progress, on the basis of a user instruction via the input device 83. The data preprocessing unit 853 then generates the training data 852 in which the labels for object type and process progress are assigned to the camera image.

For example, in the robot control system 100, the workpiece 2 and the workbench 3 are photographed using the camera 10 during the assembly work by the worker 4, the photographed image is transmitted to the learning-type control device 8, and the data preprocessing unit 853 generates the training data 852. As illustrated in FIG. 5, the training data 852 is data obtained by assigning labels for the types (part 1, part 2, and so forth) of objects appearing in an image, the position of the objects in the image, and the process progress thereof (0: supply, 2: assembly 1 complete, and so forth), to one camera image (No. 1, No. 2, and so forth) captured by the camera 10. For example, the position of an object in an image can be represented by two-dimensional coordinates by using a corner of the upper surface of the workbench 3 as a reference point.

In the work illustrated in the training data 852 of FIG. 5, a process (assembly 1) to join part 4 to part 3 is first performed followed by a process (assembly 2) to attach part 1 atop part 3, and finally, a process (assembly 3) to attach part 2 atop part 3 is performed. The image No. 1 in FIG. 5 is illustrated with a label assigned thereto indicating a state in which a plurality of parts 1 and 2 are being supplied to the workbench 3 before the assembly work (process progress is 0: supply) and a state in which the parts 3 and 4 are joined and the assembly 1 process is complete (process progress is 2: assembly 1 complete). For example, the parts (parts 1, 2, and so forth) are supplied in a state of being stored in trays indicated by solid lines.

The image No. 2 in FIG. 5 is illustrated with a label assigned thereto indicating a state in which the plurality of parts 1 and 2 are being supplied to the workbench 3 before the assembly work (process progress is 0: supply) and a state in which the parts 3 and 4 are joined and the assembly 2 process to attach part 1 to part 3 has been completed (process progress is 3: assembly 2 complete).

The image No. 3 in FIG. 5 is illustrated with a label assigned thereto indicating a state in which the plurality of parts 1 and 2 are being supplied to the workbench 3 before the assembly work (process progress is 0: supply) and a state in which all of the parts 1 to 4 are joined and the assembly 3 process has been completed (process progress is 4: assembly 3 complete). The data preprocessing unit 853 creates a plurality of pieces of data in which a label is assigned to one camera image as illustrated in FIG. 5 according to the content thereof, and uses a plurality of images to which labels have been assigned as the training data 852.

The learning processing unit 855 performs machine learning on the learning model 856 by means of the training data 852 generated by the data preprocessing unit 853. The learning processing unit 855 includes a learning model 856 that receives the camera images of the training data 852 as inputs and outputs an estimation result of the object types and the process progress, and a parameter update amount arithmetic unit 857. The learning model 856 is configured using a neural network, for example.

The parameter update amount arithmetic unit 857 compares the object type and the process progress of the training data 852 with the estimated object type and the estimated process progress of the learning model 856, and calculates the update amount of a model parameter of the learning model 856 so that the content of the training data 852 matches the output of the learning model 856. For example, in a case where a neural network is used for the learning model 856, the model parameter is a weighting such as the degree of coupling between the neurons constituting the neural network or a threshold value for neuron firing.

The learning processing unit 855 then continues to update the model parameter of the learning model 856 according to the update amount calculated by the parameter update amount arithmetic unit 857 until a predetermined condition is reached, and in a case where the predetermined condition is reached, stores the model parameter of the learning model 856 at that time as the model parameter data 862. For example, the predetermined condition is that the respective errors between the object type and the process progress of the training data 852 and the estimated object type and the estimated process progress of the learning model 856 are equal to or less than a predetermined value. As another condition, the number of model parameter updates may be set.

Note that the neural network of the learning model 856 illustrated in FIG. 4 illustrates a simple multi-layer perceptron (MLP), but a different network may be used. For example, the neural network of the learning model 856 may be configured using a convolutional neural network (CNN), a recurrent neural network (RNN), or the like, or may be configured by combining these networks. Furthermore, the learning method of the learning model 856 is not limited to machine learning by deep learning using a neural network, and may be another learning method.

### [Method of Selecting Action]

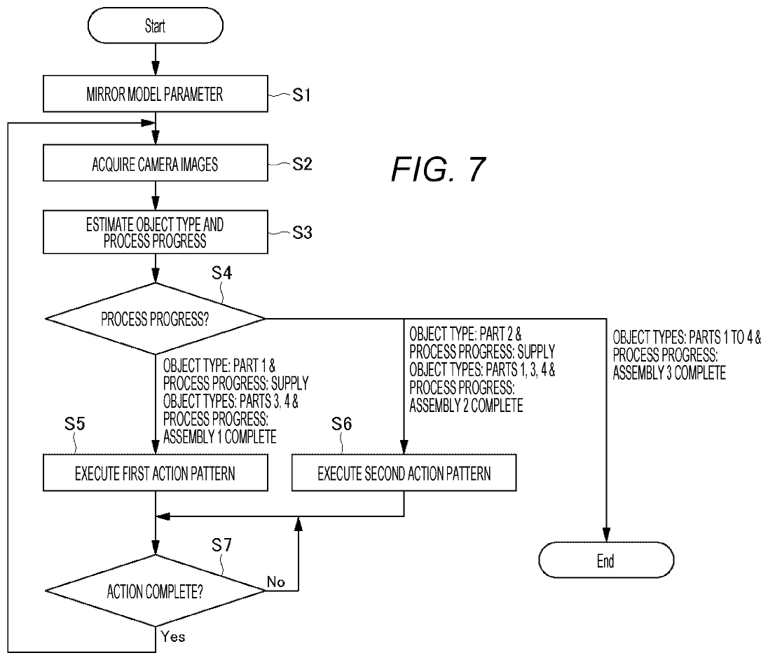

Next, a method in which the learning-type control device 8 estimates the progress of the work process and selects the action content of the robot device 1 will be described with reference to FIGS. 6 and 7.

FIG. 6 is a schematic view illustrating an example of a software configuration of the action command program 861 stored in a learning-type control device 8 of the robot control system 100.

The arithmetic processing unit 863 has the learning model 856 which mirrors the model parameter data 862, receives a camera image via the communication interface 82 as an input, and outputs the estimated object type and the estimated process progress of the workpiece 2.

The action selection unit 864 selects the action content of the robot device 1 on the basis of the estimated object type and the estimated process progress outputted by the arithmetic processing unit 863.

The first action pattern generation unit 865 generates a first action pattern (action command) for realizing the action content according to the action content.

The second action pattern generation unit 866 generates a second action pattern (action command) for realizing action content different from the action content applied to the first action pattern generation unit 865.

The action command output switching unit 867 switches the action commands outputted from the first action pattern generation unit 865 and the second action pattern generation unit 866 according to the action selection result of the action selection unit 864.

FIG. 7 is a flowchart illustrating a procedure example of a method in which the action command program 861 executes control by using a learning model 856, in the robot control system 100. Specifically, FIG. 7 illustrates processing in which the action command program 861 selects an action of the robot device 1 by means of the arithmetic processing unit 863, the action selection unit 864, and the action pattern generation units 865, 866.

Note that all the processing steps illustrated in FIG. 7 are executed at predetermined sampling timings in the learning-type control device 8. Upon receiving an execution start command from the outside via the input device 83, the learning-type control device 8 deploys the action command program 861 stored in the storage device 84, in the control device 81 and executes the action command program. When deployed in the RAM of the control device 81 and executed by the CPU, the action command program 861 is configured to include, as software modules, an arithmetic processing unit 863, an action selection unit 864, a first action pattern generation unit 865, a second action pattern generation unit 866, and an action command output switching unit 867.

When the action command program 861 is started, the arithmetic processing unit 863 mirrors the model parameter data 862 in the learning model 856 (S1), and enters a state of being capable of estimating the object type and the process progress of the workpiece 2. Subsequently, the arithmetic processing unit 863 acquires the camera images captured by the camera 10 via the communication interface 82 (S2). Next, the arithmetic processing unit 863 uses the learning model 856 to estimate the object type and the process progress of the workpiece 2 appearing in the camera image, and outputs the estimation result to the action selection unit 864 (S3).

The action selection unit 864 distributes the subsequent processing according to the content of the estimation result of the process progress (S4). For example, in a case where the estimation result outputted by the arithmetic processing unit 863 includes the object type “part 1” and the process progress “part supply” (0: supply), and the object types “parts 3, 4” and the process progress “assembly 1 process is complete” (2: assembly 1 complete), the process advances to step S5. The action selection unit 864 then switches the output of the action command output switching unit 867 such that the robot device 1 executes the first action pattern (S5).

Further, in step S4, when the estimation result outputted by the arithmetic processing unit 863 includes the object type “part 2” and the process progress “part supply” (0: supply), and the object type “parts 1, 3, and 4” and the process progress “assembly 2 process is complete” (3: assembly 2 complete), the process advances to step S6. The action selection unit 864 then switches the output of the action command output switching unit 867 such that the robot device 1 executes the second action pattern (S6).

Furthermore, in step S4, in a case where the estimation result outputted by the arithmetic processing unit 863 includes the object type “parts 1 to 4” and the process progress “assembly 3 process is complete” (4: assembly 3 complete), the action selection unit 864 determines that the assembly work has been completed, and ends the processing.

Note that the first action pattern executed in step S5 is an action of gripping part 1 and attaching same to part 3 in a situation as illustrated in image No. 1 in FIG. 5, and that the second action pattern executed in step S6 is an action of gripping part 2 and attaching same to part 3 in a situation as illustrated in image No. 2 in FIG. 5.

Next, in a case where the processing of step S5 or step S6 is executed, the action selection unit 864 determines whether the action according to the first action pattern or the action according to the second action pattern has been completed (S7). As an example, the action selection unit 864 monitors the outputs of the action command output switching unit 867, and determines action completion according to the presence or absence of an action command outputted by the first action pattern generation unit 865 or the second action pattern generation unit 866. Further, when an action command output has not been completed (No in S7), the action selection unit 864 continues to stand by. On the other hand, in a case where an action command output has been completed (Yes in S7), the action selection unit 864 returns the processing to step S2, estimates the object type and the process progress again and switches the action command, until the work is complete. Note that the action command output switching unit 867 may write information to a flag upon outputting an action command, and the action selection unit 864 may determine action completion on the basis of the authenticity of the information. In addition, the action selection unit 864 may be configured to determine action completion on the basis of a camera image acquired by the camera 10.

Note that, in order to simplify the description, the selection of the action according to the determination result in step S4 and the output of the action pattern (action command) in steps S5 and S6 are described in only two ways, but the present invention is not limited to only two ways. For example, it is obvious that the configuration may be such that three or more action patterns can be selected according to the type of the process progress subjected to machine learning by the learning model 856.

Further, the first action pattern generation unit 865 and the second action pattern generation unit 866 may be configured to input position information in the image of each object (or camera images) estimated by the arithmetic processing unit 863. For example, the first action pattern generation unit 865 and the second action pattern generation unit 866 may be configured to adjust the action content to change an object holding position or the posture of the end effector 12 according to the position information of each object in the image.

The action command program 861 includes two action pattern generation units, that is, a first action pattern generation unit 865 and a second action pattern generation unit 866, but there may also be one action pattern generation unit. In this case, one action pattern generation unit generates a plurality of different action patterns (action commands) according to the work process. The action command output switching unit 867 selects an action pattern from a plurality of action patterns generated by one action pattern generation unit, on the basis of an estimation result including the process progress.

As described above, the robot control system (robot control system 100) according to the first embodiment includes: a robot device (robot device 1); a work status sensor (camera 10) that acquires information indicating a work status of the robot device with respect to a workpiece; an arithmetic processing unit (an arithmetic processing unit 863) that estimates and outputs a workpiece type and progress of a current work process, which correspond to information indicating a current work status acquired by the work status sensor by using a learning model (learning model 856) subjected to machine learning by means of training data (training data 852) which includes the information indicating the work status acquired by the work status sensor, the workpiece type, and the progress of the work process; at least one or more action pattern generation units (action pattern generation units 865, 866) that generate an action pattern of the robot device corresponding to the current work process; and an action selection unit (action selection unit 864) that selects the action pattern generation unit on the basis of the workpiece type and the work process progress outputted by the arithmetic processing unit.

The robot control system 100 according to the first embodiment described above uses the learning model 856 trained to estimate the type of the workpiece 2 and the progress of the work process with respect to the information indicating the work status of the robot device 1. The robot control system 100 (action command program 861) determines an action pattern (action content) of the robot device 1 on the basis of the progress of the current work process estimated by the learning model 856. As a result, the robot control system 100 is capable of causing the robot device 1 to execute an appropriate action in work that requires a plurality of steps. Further, because the robot control system 100 is capable of outputting an appropriate action command to the robot device 1 with respect to work constituted by a plurality of processes, the robot control system can be applied to a work site where the work content changes frequently.

### Second Embodiment

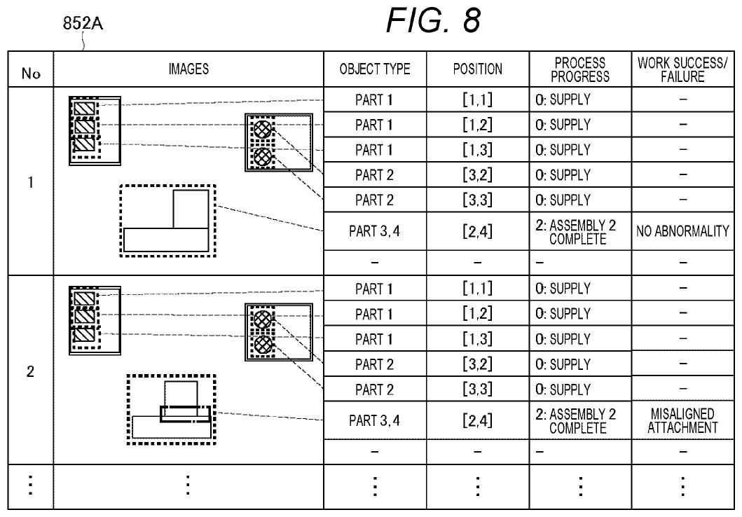

As a second embodiment, a method of determining success or failure of work in accordance with progress of a work process and selecting action content will be described with reference to FIG. 8. Note that the robot control system according to the second embodiment has the same basic configuration as the robot control system 100 according to the first embodiment, but the content of the training data used in machine learning is different.

### [Training Data]

FIG. 8 is a schematic view illustrating an example of training data which a learning program 851 uses in machine learning of a learning model 856, in the robot control system according to the second embodiment. The training data 852A illustrated in FIG. 8 is data obtained by assigning a label of work success/failure (no abnormality, attachment misalignment, and so forth) of the corresponding process to one camera image (No. 1, No. 2, and so forth) captured by the camera 10, in addition to the type (part 1, part 2, and so forth) of the object appearing in the image, the position of the object in the image, and the process progress (0: supply, 2: assembly 2 complete, and the like).

For example, the image No. 1 in FIG. 8 is assigned a label indicating a state in which a plurality of parts 1 and 2 are being supplied to the workbench 3 before the assembly work (process progress is 0: supply) and a state in which the parts 3 and 4 are joined and the assembly 2 process has been completed without abnormality (process progress is 2: assembly 1 complete) (no abnormality).

In image No. 2 in FIG. 8, a label is assigned indicating a state in which the plurality of parts 1 and 2 are supplied to the workbench 3 before the assembly work (process progress is 0: supply), and a state in which the parts 3 and 4 are joined and the assembly 2 process has been completed (process progress is 2: assembly 2 complete) but the attachment positions are misaligned (attachment misalignment: portion indicated by a one-dot chain line).

The learning processing unit 855 (FIG. 4) performs machine learning on the learning model 856 by means of the training data 852A including the label indicating the success or failure of the work as described above. The learning model 856 (FIG. 4) subjected to machine learning by means of the training data 852A outputs estimation results for the process progress and the work success/failure on the basis of the inputs of images of the camera 10.

In the arithmetic processing unit 863, in a case where an estimation result indicating that certain work has been completed is outputted as illustrated in image No. 1 in FIG. 8, the action selection unit 864 (FIG. 6) switches the output of the action command output switching unit 867 so as to output an action command of the action pattern generation unit that is to perform the next work process. Further, in a case where an estimation result indicating that the work has failed and attachment position misalignment has occurred is outputted as illustrated in image No. 2 in FIG. 8, the action selection unit 864 switches the output of the action command output switching unit 867 so as to output an action command of the action pattern generation unit to correct the misalignment of the attachment position.

In this case, the action command program 861 can be configured to include a third action pattern generation unit that generates an action pattern for correcting the misalignment of the attachment position. For example, the action content of the third action pattern generated by the third action pattern generation unit is an action to change the relative positional relationship of the target parts so that the positional relationship between the target parts becomes a correct position, or an action to detach and re-attach the target parts, or the like.

As described above, in the robot control system (robot control system 100) according to the second embodiment, the learning model (learning model 856) is subjected to machine learning by means of the training data (training data 852A) including the information indicating the work status acquired by the work status sensor (camera 10), the workpiece type, the progress of the work process, and correctness of the work in the work process, and the learning model is configured to, when the information indicating a current work status acquired by the work status sensor is inputted, estimate the success or failure of the work in the current work process in addition to the workpiece type and the progress of the current work process which are included in the information indicating the current work status.

The action selection unit (action selection unit 864) is configured to select the action pattern generation unit (action pattern generation unit 865, 866) on the basis of the workpiece type, the progress of the current work process, and the success/failure of the work in the work process, which are outputted by the arithmetic processing unit (arithmetic processing unit 863) by using the learning model (learning model 856).

Further, in the robot control system (robot control system 100) according to the present embodiment, in a case where the action selection unit (action selection unit 864) estimates that the work in the current work process has not been completed in the arithmetic processing unit (arithmetic processing unit 863), the action selection unit is configured to select, from among the action pattern generation units (action pattern generation unit 865, 866), the action pattern generation unit which generates an action pattern for completing the work in the corresponding work process.

Furthermore, in the robot control system (robot control system 100) according to the present embodiment, the action pattern for completing work in the corresponding work process is an action pattern (for example, the third action pattern) for performing the work to correct a work result according to an action pattern (for example, the first or second action pattern) generated by the action pattern generation unit previously selected by the action selection unit (action selection unit 864).

As described above, in the second embodiment, the work success/failure is estimated in accordance with the progress of the current work process, and the action content of the robot device 1 is selected on the basis of the estimation result, and thus the robot device 1 can be caused to execute an appropriate action according to the state of the workpiece 2. In addition, even in a case where the work fails, because the robot device 1 acts autonomously to recover the work, intervention by the worker 4 or the like becomes unnecessary, and thus the work efficiency of the entire site is improved.

Note that the same processing is performed not only in a case where the work fails but also in a case where the work is interrupted for some reason and the work is not completed as a result. Similarly, in a case where the work is interrupted, the action selection unit 864 selects the action pattern generation unit so as to continue the work from the work status (work result) at the time of interruption, and complete the work.

### Third Embodiment

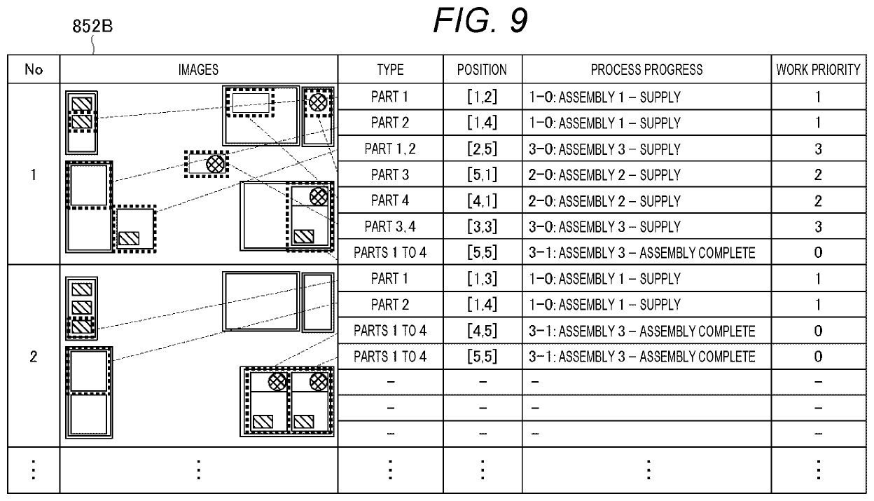

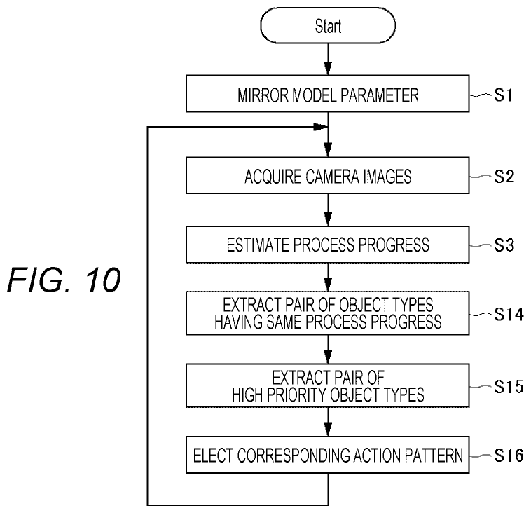

As a third embodiment, a method of calculating the type of each work process in a plurality of independent work processes and the progress of each work process and selecting the action content of the robot device 1 will be described with reference to FIGS. 9 and 10. Note that the robot control system according to the third embodiment has the same basic configuration as the robot control system 100 according to the first embodiment.

FIG. 9 is a schematic view illustrating an example of training data which a learning program 851 uses in machine learning of a learning model 856, in the robot control system according to the third embodiment.

The training data 852B illustrated in FIG. 9 is data obtained by assigning a label of work priority (1, 2, and so forth) to one camera image (No. 1, No. 2, and so forth) captured by the camera 10, in addition to the type of the object appearing in the image, the position of the object in the image, and the process progress (1-0: assembly 1—supply, 3-1: assembly 3—assembly complete, and the like). The higher the value of the work priority is, the higher the priority which is set. Note that the shapes of parts 1 to 4 here do not correspond to the shapes of parts 1 to 4 illustrated in FIGS. 5 and 8.

The assembly work illustrated in the training data 852B of FIG. 9 includes three processes, namely, a process to couple part 2 to part 1 (assembly 1), a process to attach part 4 to part 3 (assembly 2), and a process to couple the assembled parts 1 and 2 and the assembled parts 3 and 4 (assembly 3). At this time, assuming that the assembly 1 process, the assembly 2 process, and the assembly 3 process are independent from each other, the three processes may be executed from any process. The assembled parts 1 and 2 and the assembled parts 3 and 4 may also be temporarily placed on the workbench 3.

In a case where the assembly work as described above is performed at a work site as illustrated in FIG. 3, the supply and unloading of parts become intermittent according to the production status, and the supply of necessary parts to the workbench 3 and the unloading of parts from the workbench 3 may not be completed in time. Therefore, it is necessary to set a work priority for each process.

In a situation like that of the image illustrated in No. 1 of FIG. 9, because the parts 1 to 4 or the assembled products resulting therefrom are in a proper state, any process among assemblies 1 to 3 can be performed. However, in a situation like that of the image illustrated in No. 2 of FIG. 9, the part 3 and the part 4 are not supplied. Therefore, in this situation, it is desirable to carry out the work such that the assembly 1 process is performed first, the assembled parts 1 and 2 are placed temporarily, the assembly 2 process, in which part 4 is attached to part 3, is performed as soon as part 3 and part 4 are supplied, and the assembly 3 process is performed after the assembly 2 process. Using such a work sequence, the waiting time of the robot device 1 can be reduced.

Note that, as described above, each process is independent, and it is necessary to select a process to be performed by the robot device 1 even when any executable process may be performed. Therefore, the work priority is set, and a process having a high work priority is performed. For example, in a situation like that of image No. 1 in FIG. 9, the priority of the assembly 3 process is set high so that a finished product is created as soon as possible and is carried out by the automatic conveyance vehicle 5 (work priority “3”). Furthermore, because there is no work to be performed by the robot device 1 on the finished product obtained by assembling parts 1 to 4, the priority is set to the smallest value (work priority “0”).

Next, a method in which, in the robot control system according to the third embodiment, an action command program 861 executes control by using a learning model 856 subjected to machine learning by means of the training data 852B will be described with reference to FIG. 10.

FIG. 10 is a flowchart illustrating a procedure example of a method in which the action command program 861 executes control by using the learning model 856 subjected to machine learning by means of the training data 852B. Specifically, FIG. 10 illustrates processing in which the action command program 861 selects an action of the robot device 1 by means of the arithmetic processing unit 863, the action selection unit 864, and the action pattern generation units 865, 866.

Similarly to the processing illustrated in steps S1 to S3 in FIG. 7, when the action command program 861 is started, the arithmetic processing unit 863 mirrors the model parameter data 862 in the learning model 856 (S1), and enters a state of being capable of estimating the object type and the process progress. Next, the arithmetic processing unit 863 acquires the camera images captured by the camera 10 (S2), then uses the learning model 856 to estimate the object type and the process progress, and outputs the estimation result (S3).

Next, the action selection unit 864 extracts a combination (pair) of object types having the same process progress from among the plurality of object types and the process progress outputted by the arithmetic processing unit 863 (S14). In the case of the image illustrated in No. 1 of FIG. 9, a pair of part 1 and part 2, a pair of part 3 and part 4, and a pair of the assembled parts 1 and 2 and the assembled parts 3 and 4 are extracted. In addition, in the case of the image illustrated in No. 2 of FIG. 9, a pair of part 1 and part 2, and a pair of finished products of part 1 to part 4 finished using the assembly 3 process are extracted.

Next, the action selection unit 864 extracts a pair of object types having the highest work priority from among the extracted object type pairs (S15). In the case of the image illustrated in No. 1 of FIG. 9, pairs of the assembled parts 1 and 2 and the assembled parts 3 and 4 having the work priority “3” are extracted. In addition, in the case of a state like that of the image illustrated in No. 2 of FIG. 9, a pair of part 1 and part 2 having the work priority “1” is extracted.

Finally, the action selection unit 864 selects the action pattern of the robot device 1 corresponding to the extracted object type pair (S16). In the case of the image illustrated in No. 1 of FIG. 9, because the object types are the assembled parts 1 and 2 and the assembled parts 3 and 4, and the process progress is in a state where the parts have been supplied in the assembly 3 process, the arithmetic processing unit 863 selects the action of performing the assembly 3. In addition, in the case of the image illustrated in No. 2 of FIG. 9, because the object types are part 1 and part 2 and the process progress is in a state where the part has been supplied in the assembly 1 process, the arithmetic processing unit 863 selects the action of performing the assembly 1.

Note that the method of extracting the object types is not limited to the above-described method, rather, the object types of the same process may be simultaneously extracted from among three or more object types. In the present embodiment, the work to be performed is determined by the magnitudes of the work priorities so that actions are uniquely selected, but work priorities need not be limited to predetermined fixed values. For example, a work priority may be changed according to the operating status of the automatic conveyance vehicle 5 or the positional relationship between the robot device 1 and the workbench 3.

In addition, the work priority may be changed according to the type and the number of articles temporarily placed on the workbench 3, the number of processes completed by the robot device 1, and the like. For example, adjusting priorities so that each process is executed in a balanced manner may be considered. Furthermore, by configuring the magnitudes of the work priorities to be changeable according to the images acquired by the camera 10 at the time the training data 852B is generated, the administrator of the robot control system may perform settings to render the order of the processes adjustable by using the input device 83. As an example, making adjustments to prioritize work utilizing parts of which there are a large number appearing in the image may be considered.

As described above, in the robot control system (robot control system 100) according to the third embodiment, the learning model (learning model 856) is subjected to machine learning by means of training data (training data 852B) that includes information indicating the work status acquired by the work status sensor (camera 10), the workpiece type, the respective work process types of a plurality of independent work processes, and the progress of each work process, and is configured such that, when information indicating a current work status acquired by the work status sensor is inputted, the learning model estimates the workpiece type, the types of the plurality of independent work processes, and the progress of each of the current work processes, which are included in the information indicating the current work status.

The action selection unit (action selection unit 864) is configured to select the action pattern generation unit (action pattern generation unit 865, 866) corresponding to an executable work process among the plurality of independent work processes on the basis of the workpiece type, the types of the plurality of independent work processes, and the progress of each of the current work processes, which are outputted by the arithmetic processing unit (arithmetic processing unit 863) by using the learning model (learning model 856).

Furthermore, in the robot control system (robot control system 100) according to the present embodiment, the training data (training data 852B) includes a priority of each work process in addition to the information indicating the work status acquired by the work status sensor (camera 10), the workpiece type, the types of the respective work processes of the plurality of independent work processes, and the progress of each of the current work processes.

The action selection unit (action selection unit 864) is configured to select an action pattern generation unit (action pattern generation units 865, 866) corresponding to a work process having a high priority.

As described above, according to the third embodiment, in the work of carrying out the plurality of independent work processes, executable action content is determined according to the process progress of each work process, and the action pattern generation unit corresponding to the action content is selected. Thus, because the waiting time of the robot device 1 can be reduced, the operating time of the robot device 1 increases, and the work efficiency can be improved.

### Fourth Embodiment

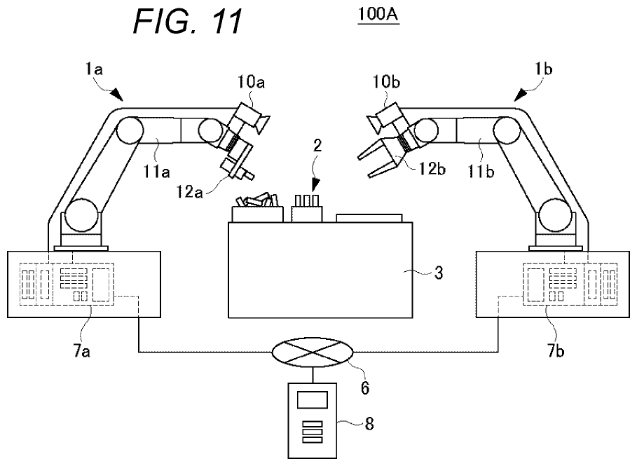

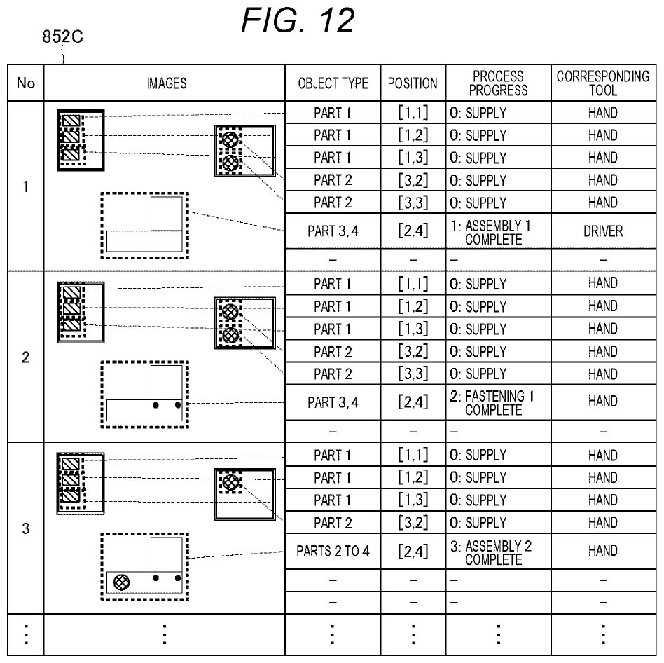

As a fourth embodiment, a method of estimating a tool corresponding to the process execution along with the progress of the work process, and selecting the action content of the robot device 1 on the basis of the estimation result will be described with reference to FIGS. 11 and 12.

FIG. 11 is a schematic view illustrating an example of the overall configuration of a robot control system according to the fourth embodiment. The illustrated robot control system 100A is different from the robot control system 100 according to the first embodiment in that it includes two robot devices, but other basic functions are the same. Hereinafter, differences between the robot control system 100A and the robot control system 100 according to the first embodiment will be mainly described.

The robot control system 100A includes a robot device 1a and a robot device 1b. The robot device 1a includes an end effector 12a at the distal end of a robot arm 11a, and performs work with respect to the workpiece 2 on the workbench 3. Further, the robot device 1b includes an end effector 12b different from the end effector 12a at the distal end of a robot arm 11b, and performs work with respect to the workpiece 2 on the workbench 3. A robot control device 7a for controlling the robot device 1a and a robot control device 7b for controlling the robot device 1b are connected to the learning-type control device 8 via the network 6.

FIG. 12 is a schematic view illustrating an example of training data which a learning program 851 uses in machine learning of a learning model 856, in the robot control system 100A according to the fourth embodiment. The illustrated training data 852C is data obtained by assigning labels (hand, screwdriver, and the like) of tools to be used in the next process to one camera image (No. 1, No. 2, and so forth) captured by the camera 10, in addition to the type of the object appearing in the image, the position of the object in the image, and the process progress.

Depending on the work content performed by the robot devices 1a and 1b, work may be advanced by changing the tool to be used for the workpiece 2, and the work is performed by switching between the robot devices 1a and 1b according to the progress of the work process. For example, as illustrated in image No. 1 in FIG. 12, the robot device 1b performs a process (assembly 1) to attach part 3 to part 4 by using the end effector 12b (hand), which is capable of gripping part 3 and part 4.

As illustrated in the image No. 2 in FIG. 12, the robot device 1a performs a process (fastening 1) to fasten the assembled parts 3 and 4 with screws by using the end effector 12a (screwdriver), which is capable of screw fastening. Further, as illustrated in image No. 3 in FIG. 12, the robot device 1b performs a process (assembly 2) to attach part 2 to the assembled parts 3 and 4 again by using the end effector 12b (hand), which is capable of gripping part 2.

The action selection unit 864 illustrated in FIG. 6 switches the output of the action command output switching unit 867 so as to output the action command of the action pattern generation unit 865 or 866 corresponding to the robot device 1a or 1b on the basis of the process progress and the estimation result of the corresponding tool in the arithmetic processing unit 863. For example, in a state like that of image No. 1 in FIG. 12, the learning-type control device 8 outputs, to the robot device 1a via the network 6, an action command of the first action pattern generation unit 865 corresponding to the process (fastening 1) of fastening parts 3 and 4 with screws. In a state like that of image No. 2 in FIG. 12, the action command of the second action pattern generation unit 866 corresponding to the process (assembly 2) of attaching part 2 to the assembled parts 3 and 4 is outputted to the robot device 1b via the network 6.

Note that the selection of the action pattern is not limited to the method described above. At the site as illustrated in FIG. 3, the configuration may be such that a process that can be carried out by one robot device may be performed on a plurality of workpieces 2, and such that a plurality of parts midway through assembly are temporarily placed on the workbench 3 and the robot device moves in this state while another robot device takes over the process instead.

For example, the robot device 1b performs a process (assembly 1) to attach part 4 to part 3 as illustrated in image No. 1 in FIG. 12 a plurality of times, and temporarily places a plurality of the assembled parts 3 and 4 on the workbench 3. The process to attach part 4 to part 3 is repeated until the work space on the workbench 3 is exhausted or there is no more part 3 or part 4. The robot device 1b then moves onto a different workbench 3, and the robot device 1a performs a process (fastening 1) to fasten the assembled parts 3 and 4 with screws as illustrated in the image No. 2 in FIG. 12.

Further, the robot device 1b moves to a different workbench 3, and performs a process (assembly 1) to attach part 4 to part 3 as illustrated in image No. 1 in FIG. 12 on the workbench 3 serving as the movement destination. In this manner, the robot device 1a and the robot device 1b may be configured to advance the process alternately. That is, the action may be switched according to the positions of the respective robot devices, the number of workpieces 2, and the progress of the work process.

As described above, the robot control system (robot control system 100A) according to the fourth embodiment includes two or more robot devices (robot devices 1a, 1b) on which different end effectors (end effectors 12a, 12b) are mounted.

The action selection unit (action selection unit 864) selects the action pattern generation units (action pattern generation units 865, 866) corresponding to any of the two or more robot devices on the basis of the workpiece type and the progress of the current work process which are outputted by the arithmetic processing unit (arithmetic processing unit 863).

In the fourth embodiment described above, the action pattern (action pattern generation unit) is selected such that the robot device corresponding to the end effector required according to the progress of the work process performs the action. As a result, it is possible to smoothly perform work that includes a plurality of processes and in which the appropriate tools change depending on the processes. In addition, because the configuration is such that the action of the plurality of robot devices is switched according to the number of workpieces and the progress of the work process, the respective waiting times of the robot devices can be reduced and the work efficiency can be improved.

### <Modifications>

Note that the present invention is not limited to or by the first to fourth embodiments described above, and it is understood that various other application examples and modifications can be adopted without departing from the spirit of the present invention set forth in the claims.

For example, in each of the above-described embodiments, the configuration of the robot control system has been described in detail and in specific terms in order to describe the present invention in a manner which is easy to understand, and the present invention is not necessarily limited to an invention that includes all the described constituent elements. In addition, part of the configuration of one embodiment can be replaced with a constituent element of another embodiment. Constituent elements of other embodiments can also be added to the configuration of the one embodiment. Moreover, it is also possible to add or delete another constituent element to/from part of the configuration of each embodiment, or to replace part of the configuration with another constituent element.

Furthermore, the robot devices 1, 1a, and 1b used in the first to fourth embodiments described above represent examples of a vertical articulated robot, but may also be an orthogonal coordinate robot, a horizontal articulated robot, a parallel link robot, or the like. In addition, the present invention is not limited to being an industrial robot like that illustrated by way of example, and may also be applied to a robot control system for controlling an autonomous robot or an outdoor work robot (outdoor work machine).

Further, as the work status sensor that measures the work status of the robot device 1, a device other than the camera 10 may be used, or a distance measuring device utilizing optical or radio waves may be used. For example, the configuration may be such that the shape, position, and posture of the workpiece 2 and surrounding objects are measured using LIDAR (Light Detection and Ranging, Laser Imaging Detection and Ranging), which is a distance measuring device utilizing a laser. In a case where a distance measuring device is used as the work status sensor, the work status sensor obtains point cloud data (distance measurement data) in which a reflected signal obtained from the workpiece 2 or surrounding objects is associated with the position in which the reflected signal was obtained.

Further, the work status sensor may be installed in an environment (such as a building at a site) where the mobile carriage 9 whereon the robot device 1 is installed moves.

Furthermore, the action pattern generation units 865, 866 may be configured to capture a joint angle of the robot arm 11 and camera images from the camera 10 and to perform feedback control. In addition, a control method may be used in which machine learning is implemented to output an appropriate action command, on the basis of the camera images, to the action pattern generation units 865, 866.

Moreover, some or all of the above-described configurations, functions, processing units, and the like may be realized by hardware, for example, by a design using an integrated circuit. A processor device in a broad sense such as a field programmable gate array (FPGA) or an application specific integrated circuit (ASIC) may be used as the hardware.

### REFERENCE SIGNS LIST

1 robot device
2 workpiece
7 robot control device
8 learning-type control device
10 camera
12 end effector
100 robot control system
851 learning program
852 training data
855 learning processing unit
856 learning model
861 action command program
862 model parameter data
863 arithmetic processing unit
864 action selection unit
865 first action pattern generation unit
866 second action pattern generation unit
867 action command output switching unit

1. A robot control system, comprising:
a robot device;
a work status sensor that acquires information indicating a work status of the robot device with respect to a workpiece;
an arithmetic processing unit that estimates and outputs a workpiece type and progress of a current work process, which correspond to information indicating a current work status acquired by the work status sensor by using a learning model subjected to machine learning by means of training data which includes the information indicating the work status acquired by the work status sensor, the workpiece type, and the progress of the work process;
at least one or more action pattern generation units that generate an action pattern of the robot device corresponding to the current work process; and
an action selection unit that selects the action pattern generation unit on the basis of the workpiece type and the work process progress outputted by the arithmetic processing unit.

2. The robot control system according to claim 1,
wherein the learning model is subjected to machine learning by means of the training data including the information indicating the work status acquired by the work status sensor, the workpiece type, the progress of the work process, and correctness of the work in the work process, and the learning model is configured to, when the information indicating a current work status acquired by the work status sensor is inputted, estimate the success or failure of the work in the work process in addition to the workpiece type and the progress of the current work process which are included in the information indicating the current work status, and
wherein the action selection unit selects the action pattern generation unit on the basis of the workpiece type, the progress of the current work process, and the success/failure of the work in the work process, which are outputted by the arithmetic processing unit by using the learning model.

3. The robot control system according to claim 2,
wherein, in a case where the action selection unit estimates that the work in the current work process has not been completed in the arithmetic processing unit, the action selection unit selects, from among the action pattern generation units, the action pattern generation unit which generates an action pattern for completing the work in the corresponding work process.

4. The robot control system according to claim 3,
wherein the action pattern for completing the work in the corresponding work process is an action pattern for performing the work to correct a work result according to an action pattern generated by the action pattern generation unit previously selected by the action selection unit.

5. The robot control system according to claim 1,
wherein the learning model is subjected to machine learning by means of training data that includes information indicating the work status acquired by the work status sensor, the workpiece type, respective work process types of a plurality of independent work processes, and the progress of each work process, and is configured such that, when information indicating a current work status acquired by the work status sensor is inputted, the learning model estimates the workpiece type, the types of the plurality of independent work processes, and the progress of each of the current work processes, which are included in the information indicating the current work status, and
wherein the action selection unit selects the action pattern generation unit corresponding to an executable work process among the plurality of independent work processes on the basis of the workpiece type, the types of the plurality of independent work processes, and the progress of each of the current work processes, which are outputted by the arithmetic processing unit by using the learning model.

6. The robot control system according to claim 5,
wherein the training data includes a priority of each work process in addition to the information indicating the work status acquired by the work status sensor, the workpiece type, the types of the respective work processes of the plurality of independent work processes, and the progress of each of the current work processes, and
wherein the action selection unit selects the action pattern generation unit corresponding to a work process having a high priority.

7. The robot control system according to claim 1, further comprising
two or more robot devices on which different end effectors are mounted,
wherein the action selection unit selects the action pattern generation unit corresponding to any of the two or more robot devices on the basis of the workpiece type and the progress of the current work process which are outputted by the arithmetic processing unit.

8. The robot control system according to claim 1,
wherein the work status sensor is attached to the robot device and is an imaging device that captures an image including at least the workpiece as the information indicating the work status of the robot device.

9. The robot control system according to claim 1,
wherein the robot device has a robot arm constituted by one or more joints, and an end effector.

10. A robot control system, comprising:
an arithmetic processing unit that estimates and outputs a workpiece type and progress of a current work process, which correspond to information indicating a current work status acquired by a work status sensor by using a learning model subjected to machine learning by means of training data which includes the information indicating a work status of a robot device with respect to a workpiece acquired by the work status sensor, the workpiece type, and the progress of the work process;
at least one or more action pattern generation units that generate an action pattern of the robot device corresponding to the current work process; and
an action selection unit that selects the action pattern generation unit on the basis of the workpiece type and the progress of the current work process, which are outputted by the arithmetic processing unit.

11. A robot control method, comprising the processing steps of:
estimating and outputting a workpiece type and progress of a current work process, which correspond to information indicating a current work status acquired by a work status sensor by using a learning model subjected to machine learning by means of training data which includes the information indicating a work status of a robot device with respect to a workpiece acquired by the work status sensor, the workpiece type, and the progress of the work process; and
selecting an action pattern generation unit from among at least one or more action pattern generation units that generate an action pattern of the robot device corresponding to the work process, on the basis of the estimated workpiece type and the estimated progress of the current work process.

12. (canceled)
